(19) United States
(12) Patent Application Publication
(10) Pub. No.: US 2008/0247460 A1
(43) Pub. Date: Oct. 9, 2008

(54) Method and Apparatus For Scalable Video Adaption Using Adaption Operators For Scalable Video

(76) Inventors: Jung Won Kang, Seoul (KR); Jae Gon Kim, Daejeon-city (KR); Jin Woo Hong, Daejeon-city (KR); Yong Man Ro, Daejeon-city (KR); Young Suk Kim, Daejeon-city (KR); Cong Thang Trong, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/088,480

(22) PCT Filed: Oct. 2, 2006
(86) PCT No.: PCT/KR06/03989

§ 371 Date: Mar. 28, 2008

(30) Foreign Application Priority Data
Oct. 7, 2005 (KR) 10-2005-0094386
Dec. 22, 2005 (KR) 10-2005-0127710
Oct. 2, 2006 (KR) 10-2006-0097262

(51) Int. Cl. H04N 7/26

(52) U.S. Cl. 375/240.02; 375/E07.078

(57) ABSTRACT

An apparatus for and method of adapting a bitstream to which scalable video coding (SVC) technology is applied are provided. The apparatus for adapting a bitstream includes: an Adaptation QoS information extraction unit extracting SVC adaptation operators, and relationships between the SVC adaptation operators and the usage environment information of a terminal from the Adaptation QoS information on the bitstream to which SVC technology is applied; an Adaptation Decision Taking Engine(ADTE) unit determining the SVC adaptation operators corresponding to the usage environment of the terminal receiving the transmitted bitstream among the SVC adaptation operators; and a SVC bitstream extraction unit extracting the bitstream based on the determined SVC adaptation operator. According to the apparatus and method, scalable video can be efficiently provided for changing network environments and multimedia usage environments, through adaptation of scalable video streams using an adaptation operator suggested in Classification Scheme (AQoSJDS).

### TECHNICAL FIELD

The present invention relates to an apparatus and method of adapting a bitstream to which scalable video coding (SVC) technology is applied, and more particularly, to an apparatus and method in which a bitstream is adapted using SVC adaptation operators, and the SVC adaptation operators for the adapted bitstream is additionally described, thereby allowing the SVC adaptation operators to be used later for new adaptation.

### BACKGROUND ART

With the development of communication technology, network environments have become increasingly complicated, and a variety of multimedia content has come to be consumed through different networks and terminals. Users can now enjoy high definition (HD) video products at home, while moving, or in a car, through digital multimedia broadcasting (DMB) or mobile communication networks. Mobile communication networks support a variety of terminals, including personal digital assistants (PDAs), mobile phones, and notebook computers, and wired networks, such as ADSL, support personal computers (PCs). In the near future, it will be supported by a network integrating more varieties of terminal types such as Internet protocol TV (IPTV). The moving picture experts group (MPEG)-21 framework to provide more varieties of multimedia content efficiently supports many functions, such as digital rights management (DRM), digital item adaptation (DIA), and digital item declaration (DID).

In order to provide a variety of terminals with video streaming service in this different network environment, a consideration of quality suitable for the usage environment is essential, and content of a quality suitable for the network bandwidth, the type of terminal, and user preference must be provided. In order to more efficiently adapt multimedia content to a variety of usage environments, standardization of a scalable video coding technology is currently proceeding, and in order to adapt video content to a usage environment, direct adaptation in a bitstream is supported without the need to perform reproduction in order to adapt video content to usage environments. In this way, video content can be more efficiently and quickly adapted to network and user environments compared with the pre-method of reproducing video content to fit the usage environment.

In order to support adaptation of scalable video in the MPEG-21 framework, SVC adaptation operators of scalable video needs to be described, but so far no SVC adaptation operators for scalable video exist. Accordingly, it is difficult to efficiently describe adaptation at a bitstream level for scalable video in the MPEG-21 framework.

### DETAILED DESCRIPTION OF THE INVENTION

### Technical Problem

The present invention provides an apparatus and method of supporting adaptation of multimedia content to which scalable video coding (SVC) technology is applied.

The present invention also provides an apparatus and method in which SVC adaptation operators for appropriately performing adaptation of scalable video at a bitstream level are defined, and effective meanings and description examples for describing the descriptors are suggested, thereby performing effective adaptation suitable for a variety of networks and user environments by using described the Adaptation QoS information.

### Technical Solution

According to an aspect of the present invention, it is provided an apparatus for adapting a bitstream to which scalable video coding (SVC) technology is applied, including: an Adaptation QoS information extraction unit extracting SVC adaptation operators, and relationships between the SVC adaptation operators and the usage environment information of a terminal from the Adaptation QoS information on the bitstream to which SVC technology is applied; an Adaptation Decision Taking Engine(ADTE) unit determining the SVC adaptation operators corresponding to the usage environment of the terminal receiving the transmitted bitstream among the SVC adaptation operators; and a SVC bitstream extraction unit extracting the bitstream based on the determined SVC adaptation operators.

The Adaptation QoS information comprises information on SVC adaptation operators for spatial scalability, temporal scalability and SNR scalability among the standardized SVC adaptation operators.

The Adaptation QoS information describes relationships among usage environment information of terminal, SVC adaptation operators for spatial scalability, temporal scalability and SNR scalability, and measurements indicating the overall quality of the bitstream such as a peak SNR(PSNR) and utility rank.

The Adaptation QoS information includes descriptions paired with the bandwidth of the terminal, SVC adaptation operators for the spatial scalability, the temporal scalability and the SNR scalability, and the PSNR vector having identical degrees in the bandwidth of the terminal, SVC adaptation operators for the spatial scalability, the temporal scalability and the SNR scalability, and the PSNR vectors formed with an arbitrary degree.

The Adaptation QoS information includes descriptions paired with the bandwidth of the terminal, SVC adaptation operators for the spatial scalability and the temporal scalability having identical degrees in the bandwidth of the terminal and SVC adaptation operators for the spatial scalability and the temporal scalability formed with an arbitrary degree and expressed SVC adaptation operators for the SNR scalability in the form of a matrix.

The usage environment information comprises network environment information and user environment information, the network environment information includes a bandwidth, and the user environment information includes the the terminal characteristics or the user preferences for video quality including spatial, temporal, and SNR resolution.

The SVC adaptation operators determined by the ADTE unit comprise information on the SVC adaptation operators for the spatial scalability, the temporal scalability, and the SNR scalability among the standardized SVC adaptation operators.

The bitstream extracted by the SVC bitstream extraction unit satisfies the SVC adaptation operators for the spatial scalability, the temporal scalability, and the SNR scalability among the standardized SVC adaptation operators.

The Adaptation QoS information extraction unit extracts information on SVC adaptation operators for the spatial scalability, the temporal scalability, and the SNR scalability among the standardized SVC adaptation operators.

The ADTE unit determines optimal SVC adaptation operators for the spatial scalability, the temporal scalability, and the SNR scalability satisfying the usage environment, among the standardized SVC adaptation operators.

The ADTE unit determines an SVC adaptation operator for SNR scalability by finding the appropriate value of the SVC adaptation operator for SNR scalability that satisfies an available bandwidth of terminal in the range of the highest quality point and the base quality point for the specific value of the SVC adaptation operator for spatial scalability and the specific value of the SVC adaptation operator for temporal scalability.

The SVC bitstream extraction unit extracts the bitstream to satisfy the determined SVC adaptation operators for the spatial scalability, the temporal scalability, and the SNR scalability among the standardized SVC adaptation operators.

When the bitstream is adapted to satisfy the SVC adaptation operator for the spatial scalability among the standardized SVC adaptation operators, the SVC bitstream extraction unit numerically expresses an SVC adaptation operator for the spatial scalability corresponding to the number of the spatial enhancement layers to be truncated, and, according to the value of the SVC adaptation operator for spatial scalability, the SVC bitstream extraction unit does not perform adaptation for spatial scalability or truncates the same number of the highest spatial enhancement layers of the bitstream as the value of the SVC adaptation operator for the spatial scalability, thereby performing adaptation.

When the bitstream is adapted to satisfy the SVC adaptation operator for the temporal scalability among the standardized SVC adaptation operators, the SVC bitstream extraction unit numerically expresses an SVC adaptation operator for the temporal scalability corresponding to the number of the temporal enhancement layers to be truncated, and according to the value of the SVC adaptation operator for temporal scalability, the SVC bitstream extraction unit dose not perform adaptation for temporal scalability or truncates the same number of the highest temporal layers of the bitstream as the value of the SVC adaptation operator for the temporal scalability, thereby performing adaptation.

When the bitstream is adapted to satisfy the SVC adaptation operator for a fine grain scalability (FGS) of an SNR scalability among the standardized SVC adaptation operators, according to the SVC adaptation operator for the FGS of SNR scalability that is the ratio of the sum of bitrates of the FGS layers and part of an FGS layer to be truncated to the sum of bitrates of the entire FGS layers of the bitstream, the SVC bitstream extraction unit does not perform adaptation for the SNR scalability or truncates the FGS layers starting from the highest FGS layer.

When the bitstream is adapted to satisfy the SVC adaptation operator for a coarse grain scalability (CGS) of an SNR scalability among the standardized SVC adaptation operators, the SVC bitstream extraction unit truncates the CGS quality layers according the ratio of the sum of the bitrates of the highest CGS layers to be truncated to the sum of the bitrates of the entire CGS layers of the bitstream, thereby performing adaptation.

When the bitstream is adapted to satisfy the SVC adaptation operator for the FGS and CGS of an SNR scalability among the standardized SVC adaptation operators, according to the SVC adaptation operator for the FGS and CGS of an SNR scalability that is the ratio of the sum of the bitrates of the CGS layers to be truncated, the bitrates of the FGS layers associated to the CGS layers to be truncated, and the bitrates of the FGS layers and the part of FGS layers to be truncated to the sum of the bitrates of the entire CGS layers and the entire FGS layers of the bitstream, the SVC bitstream extraction unit truncates an appropriate number of the highest CGS layers or highest FGS layers to satisfy the ratio, thereby performing adaptation.

The Adaptation QoS information on the bitstream to which SVC technology is applied is recorded in XML format.

The apparatus may further include an Adaptation QoS information description unit describing the Adaptation QoS information of the bitstream, to which SVC technology is applied and that is adapted through the SVC bitstream extraction unit, with SVC adaptation operators.

According to another aspect of the present invention, it is provided an apparatus for adapting a bitstream to which an SVC technology is applied, including: a digital item input unit inputting the bitstream to which SVC technology is applied, and Adaptation QoS information including SVC adaptation operators for the bitstream; an usage environment information input unit in which user environment information and network environment information of a terminal to which the bitstream is transmitted is inputted; an adaptation processing unit determining the SVC adaptation operators for the bitstream based on the network environment information and the user environment information, and extracting the bitstream to satisfy the determined SVC adaptation operators; and a digital item output unit transmitting the bitstream extracted by the adaptation processing unit, to the terminal, and generating an Adaptation QoS information including the SVC adaptation operators with respect to the adapted bitstream extracted by the adaptation processing unit.

The digital item input unit may include: an Adaptation QoS information input unit in which the Adaptation QoS information described in an XML format, of the bitstream to which SVC technology is applied is inputted; and an SVC video input unit in which the bitstream to which SVC technology is applied is inputted.

The usage environment information input unit may include: a network environment information input unit obtaining network environment information including a bandwidth; and an user environment information input unit obtaining user environment information including the terminal characteristics or the user preferences for video quality including spatial, temporal, and SNR resolution.

The adaptation processing unit may include: an Adaptation QoS information extraction unit parsing Adaptation QoS information recorded in XML format and extracting SVC adaptation operators for adaptation of the bitstream to which SVC technology is applied; an ADTE unit determining optimal SVC adaptation operators based on the network environment information and the user environment information among the extracted SVC adaptation operators; and an SVC bitstream extraction unit extracting the bitstream to satisfy the determined SVC adaptation operators.

The digital item output unit may include: an adaptation SVC bitstream output unit transmitting the extracted bitstream to which SVC technology is applied, to the user terminal; and an Adaptation QoS information description unit describing the Adaptation QoS information to be used for future adaptation of the bitstream to which SVC technology is applied, in an XML format including SVC adaptation operators.

According to another aspect of the present invention, it is provided method of adapting a bitstream to which a SVC technology is applied, including: extracting SVC adaptation operators, and relationships between the SVC adaptation operators and the usage environment information of a terminal from the Adaptation QoS information of the bitstream to which SVC technology is applied; determining the SVC adaptation operators corresponding to the usage environment of the terminal receiving the transmitted bitstream among the SVC adapatation operators; and extracting the bitstream based on the determined SVC adaptation operators.

According to another aspect of the present invention, it is provided a method of adapting a bitstream to which an SVC technology is applied, including: receiving an input of the bitstream to which SVC technology is applied, and Adaptation QoS information including SVC adaptation operators for the bitstream; receiving inputs of user environment information and network environment information of a terminal to which the bitstream is transmitted is inputted; determining the SVC adaptation operators for the bitstream based on the network environment information and the user environment information, and extracting the bitstream to satisfy the determined SVC adaptation operators; and transmitting the extracted bitstream to the terminal, and generating an Adaptation QoS information including the SVC adaptation operators with respect to the adapted bitstream.

### ADVANTAGEOUS EFFECTS DESCRIPTION OF THE DRAWINGS

FIG. 1 shows the structure of an apparatus for adapting a bitstream according to an embodiment of the present invention;

FIG. 2 illustrates scalable video coding (SVC) adaptation operators according to an embodiment of the present invention;

FIG. 3 shows the structure of a network for explaining compound adaptation (re-adaptation) according to an embodiment of the present invention;

FIG. 4 illustrates a method of describing the Adaptation QoS information by using highest quality points and base quality points for adaptation of a SVC bitstream according to an embodiment of the present invention;

FIG. 5 illustrates SVC adaptation operators for adapting a SVC bitstream in the form of AQoSClassification sheme according to an embodiment of the present invention;

FIG. 6 illustrates SVC adaptation operators for adapting a SVC bitstream in the form of a Utilityfunction type according to an embodiment of the present invention;

FIG. 7 illustrates SVC adaptation operators for adapting an SVC bitstream in the form of a LookupTable type according to an embodiment of the present invention;

FIG. 8 is a flowchart illustrating a method of adapting a bitstream according to an embodiment of the present invention;

FIG. 9 is a flowchart illustrating an operation for inputting a digital item in a method of adapting a bitstream according to an embodiment of the present invention;

FIG. 10 is a flowchart illustrating an operation for inputting usage environment information in a method of adapting a bitstream according to an embodiment of the present invention;

FIG. 11 is a flowchart illustrating an operation for processing adaptation in a method of adapting a bitstream according to an embodiment of the present invention; and

FIG. 12 is a flowchart illustrating an operation for outputting a digital item in a method of adapting a bitstream.

### BEST MODE

### Mode of the Invention

The present invention will now be described more fully with reference to the accompanying drawings, in which exemplary embodiments of the invention are shown.

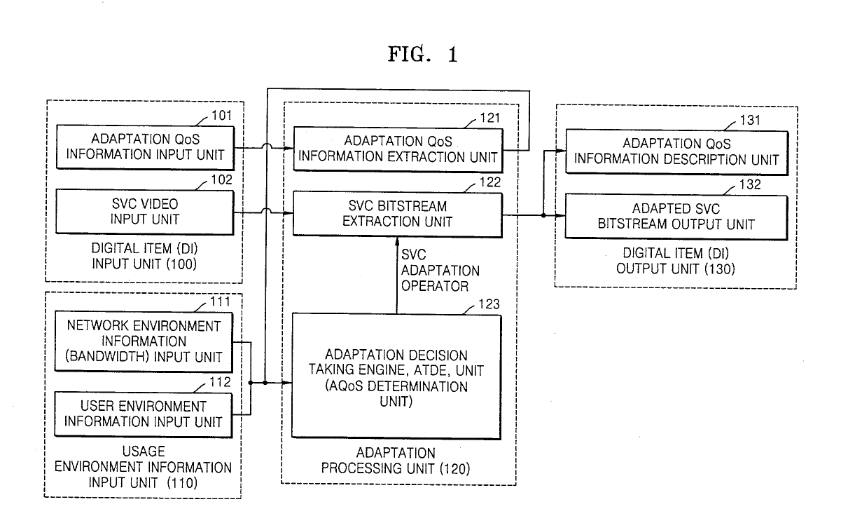

FIG. 1 shows the structure of an apparatus for adapting a bitstream according to an embodiment of the present invention. Referring to FIG. 1, the apparatus for adapting a bitstream is composed of a digital item input unit 100, an usage environment information input unit 110, an adaptation processing unit 120, and a digital item output unit 130.

The digital item input unit 100 includes an Adaptation QoS information input unit 101 and a scalable video coding (SVC) video input unit 102. Information in which a Adaptation QoS information of an SVC video stream is described in an extensible markup language (XML) format is input to the Adaptation QoS information input unit 101, and a video bitstream to which SVC technology is applied is input to the SVC video input unit 102. The digital item input unit 100 includes all functions for receiving individual digital items.

By parsing the XML formatted Adaptation QoS information description through the Adaptation QoS information input unit 101, the Adaptation QoS information is extracted for adaptation of SVC video obtained in the Adaptation QoS information extracting unit 121.

The usage environment information input unit 110 includes a function for obtaining information on the usage environment of an individual digital item input through the digital item input unit 100. The usage environment information input unit 110 includes a network environment information input unit 111 and a user environment information input unit 112.

The network environment information input unit 111 includes a function for obtaining network environment information for transmission of an SVC video stream. The user environment information input unit 112 includes a function for obtaining the environment information of a user (the terminal characteristics or the user preferences for video quality including spatial, temporal, and SNR resolution) for using an SVC video stream.

In order to perform SVC adaptation, the digital item input unit 100 obtains media resources (including Adaptation QoS information) to be adapted, and the usage environment information input unit obtains environment information items for transmission and usage in a terminal. With the Information obtained in the digital item input unit 100 and the usage environment information input unit 110, the adaptation processing unit 120 performs an SVC video adaptation process.

The network information obtained by the network environment information input unit 111, the user environment information obtained by the user environment information input unit 112, and the Adaptation QoS information of an SVC bitstream extracted by the Adaptation QoS information extraction unit 121 are input to an Adaptation Decision Taking Engine unit(ATDE) 123.

The ATDE unit 123 determines information suitable for the obtained information (network and user environment) among the Adaptation QoS information extracted in the Adaptation QoS information extraction unit 121.

The information determined by the ATDE unit 123 is the form of the SVC adaptation operators, and is input to an SVC bitstream extraction unit 122. The SVC bitstream extraction unit 122 performs the actual process of extracting an SVC bitstream, and the SVC bitstream is extracted according to the SVC adaptation operators determined by the ATDE unit 123.

The SVC bitstream adapted (extracted) according to the SVC adaptation operators in the adaptation processing unit 120 is transmitted to an SVC bitstream output unit 132.

The Adaptation QoS information of the adapted SVC bitstream is redescribed by an Adaptation QoS information description unit 131 describing Adaptation QoS information for re-adaptation. The SVC bitstream is transmitted to a terminal through the digital item output unit 130.

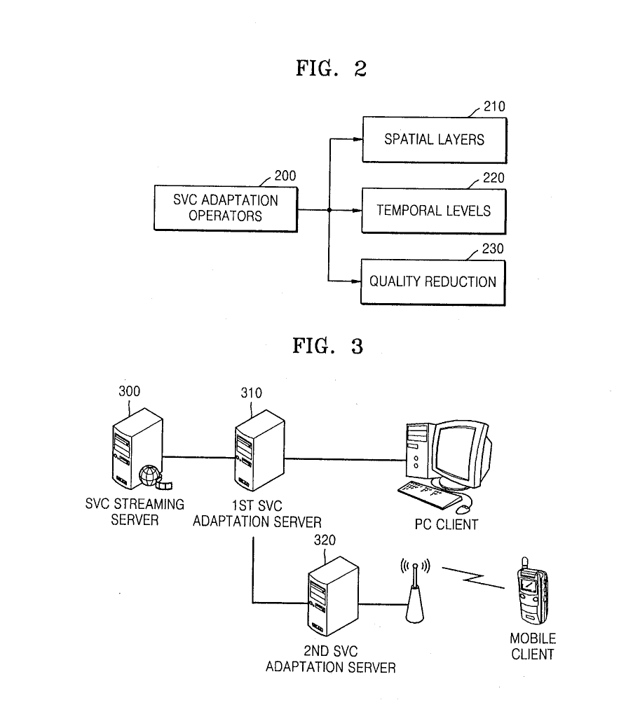

FIG. 2 illustrates scalable video coding SVC adaptation operators according to an embodiment of the present invention. Referring to FIG. 2, SVC adaptation operators 200 supporting SVC adaptation include an SVC adaptation operator for spatial scalability—Spatial Layers 210, an SVC adaptation operator for temporal Scalability—Temporal Levels 220, and an SVC adaptation operator for signal to noise ratio (SNR) Scalability—Quality Reduction 230.

SVC defines video quality with three elements: spatial resolution, temporal resolution(frame rate), and SNR quality, and performs adaptation based on these. The SVC adaptation operators 200 indicates an adaptation quality corresponding to the three elements.

In order to allow adaptation to a variety of qualities, an SVC bitstream is formed of a base layer and enhancement layers. The enhancement layer is a bitstream used for improving the spatial resolution, temporal resolution (the frame rate), and the SNR quality of a bitstream in the base layer.

The SVC adaptation operator for the spatial scalability—Spatial Layers 210 is used to increase or decrease the spatial resolution whose resolution is low or high, respectively.

The SVC adaptation operator for the temporal scalability—Temporal Levels 220 makes 30 frame/sec images into 60 frame/sec images by adding enhancement layers, as a method of increasing or decreasing temporal resolution.

The SVC adaptation operator for the SNR scalability—Quality Reduction 230 is used to increase or decrease the SNR quality of a decoded image by adding or removing an enhancement layers (or partially truncating an enhancement layer), as a method of increasing or decreasing an SNR (picture quality).

FIG. 3 shows the structure of a network for explaining compound adaptation (re-adaptation) according to an embodiment of the present invention. Referring to FIG. 3, the network is composed of an SVC streaming server 300, a first SVC adaptation server 310, and a second SVC adaptation server 320.

The necessity for describing Adaptation QoS information for re-adaptation of an adapted SVC bitstream in an environment of networks mixing a variety of network characteristics will now be explained. An SVC bitstream provided by the SVC streaming server 300 and an SVC bitstream adapted by the first SVC adaptation server 310 according to the Adaptation QoS information are adapted by the second SVC adaptation server 320 for a mobile client. At this time, the adaptation is performed by using the Adaptation QoS information (AQoS) generated by the first SVC adaptation server 310.

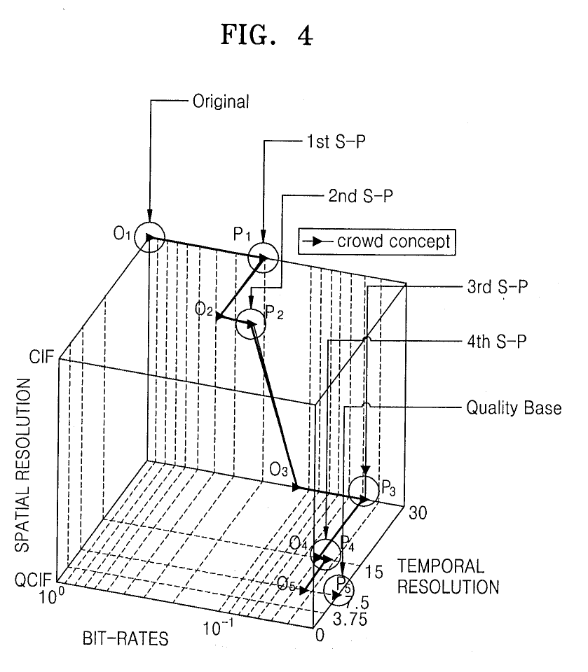

FIG. 4 illustrates a method of describing the Adaptation QoS information by using highest quality points and base quality points for adaptation of a SVC bitstream according to an embodiment of the present invention. FIG. 4 illustrates description representing entire Adaptation QoS information by using the SNR quality highest point (0) of each spatio-temporal quality interval and SNR quality base points (P1, P2, P3, P4, P5) of each spatio-temporal quality interval. The highest quality point expresses an original video quality for which adaptation is not performed, and each base quality point expresses the base point of an SNR quality in each quality interval having identical spatio-temporal quality.

This Adaptation QoS information description method indicates quality by minimum number of representative values, in relation to Adaptation QoS information with respect to a decrease in available network bandwidth, thereby enabling efficient calculation of Adaptation QoS information. Determination of Adaptation QoS information in an arbitrary interval using representative values can be explained through the following example.

Spatio-temporal quality information of an interval between the first base quality point (P1) and the second base quality point (P2) is same as the spatio-temporal quality information at the second base quality point (P2), and the SNR quality information (QualityReduction) is determined by reducing the SNR quality information of the second base quality point (P2) by the same amount as increased to a current available bandwidth. Determination of quality will be described later in more detail referring to equation 6.

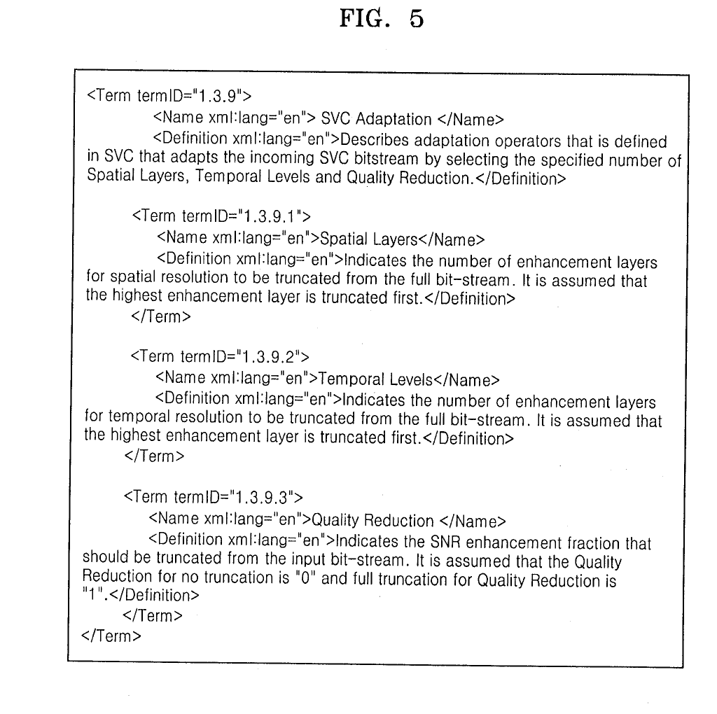

FIG. 5 illustrates SVC adaptation operators for adapting an SVC bitstream in the form of AQoSClassification sheme according to an embodiment of the present invention. In order to use SVC adaptation operators efficiently and generally, it is required to define the SVC daptation operators in AQoSClassification.

In FIG. 5, Spatial Layers indicate the number of spatial enhancement layers for spatial resolution to be truncated from the full bitstream, and for the adaptation, the highest spatial enhancement layer in the bitstream is truncated first. For example, a bitstream coded at layer 2 has integer values 0 or 1 as the value of Spatial Layers. If the value is 0, spatial quality adaptation is not performed, and if the value is 1, only the base layer is extracted and an enhancement layer (the highest layer between the base layer and the enhancement layer) is truncated.

Temporal Levels indicate the number of temporal enhancement layers for temporal resolution to be truncated, from the full bitstream and for the adaptation, the highest temporal enhancement layer in the bitstream is truncated first. For example, a bitstream coded at 30 frames/sec has integer values 0, 1, 2, 3 or 4 as the value of Temporal Levels. If the value is 0, adaptation of temporal quality is not performed (maintaining 30 frames/sec), and if the value is 1, the highest temporal enhancement layer is truncated, thereby adapting the temporal quality from 30 frames/sec to 15 frames/sec. If the value is 2, the highest temporal enhancement layer and the second highest temporal enhancement layer are truncated, thereby adapting the temporal quality to 7.5 frames/sec; if the value is 3, the highest temporal enhancement layer, the second highest temporal enhancement layer and the third highest temporal enhancement layer are truncated, thereby adapting the temporal quality to 3.75 frames/sec; and if the value is 4, the highest temporal enhancement layer, the second highest temporal enhancement layer, the third highest temporal enhancement layer and the fourth highest temporal enhancement layer are truncated, thereby adapting the temporal quality to 1.875 frames/sec.

Quality Reduction indicates the SNR enhancement fraction to be truncated for adaptation of SNR quality (SNR resolution). For example, if fine grain scalability (FGS) is used, the coded bitstream has a floating-point decimal number in 019 1 range as a value of Quality Reduction. If the value is 0.00, adaptation of the SNR quality is not performed. If the value is 1.00, all FGS enhancement layers are truncated and only the base layer is extracted, thereby performing SNR quality adaptation. If the value is 0.50, the highest FGS enhancement layers corresponding to 50% of all FGS enhancement layers are truncated, thereby performing SNR quality adaptation.

If coarse grain scalability (CGS) is used, the coded bitstream has a floating-point decimal number in 0·1 range as a value of Quality Fraction. If the value is 0.00, adaptation of the SNR quality adaptation is not performed. If the value is 1.00, all CGS enhancement layers are truncated and SNR quality adaptation is performed. For example, if two CGS layers exist, when the first CGS layer includes 60% of all the SNR quality layers, and the second CGS layer includes 40% of all the SNR quality layers, three Quality Reduction 1.00, 0.40, and 0.00 can be described in the Adaptation QoS information. If the Quality Reduction is 1.00, all CGS enhancement layers are truncated, and if the Quality Reduction is 0.40, the second CGS layer that is corresponding to 40% of all the SNR quality layers is truncated. If the Quality Reduction is 0.00, SNR quality adaptation is not performed.

If the FGS and CGS are used at the same time, for example, if 2 CGS layers exist and the FGS is applied, adaptation of more precise SNR quality is enabled compared to the case where only the CGS is used. If the first CGS layer includes 40% of all the SNR quality, the FGS layer of the first CGS layer includes 20% of all the SNR quality, the second CGS layer includes 30% of all the SNR quality, and the FGS layer of the second CGS layer includes 10% of all the SNR quality, a more precise SNR quality control, such as 0.45, is enabled while when only the CGS is used, three types of Quality Reduction, 1.00, 0.40, and 0.00, can be provided. In order to apply a Quality Reduction of 0.45, all the second CGS layers (including the associated FGS layer) are truncated, and 5% of the FGS layer of the first CGS layer is truncated, thereby adapting the SNR quality.

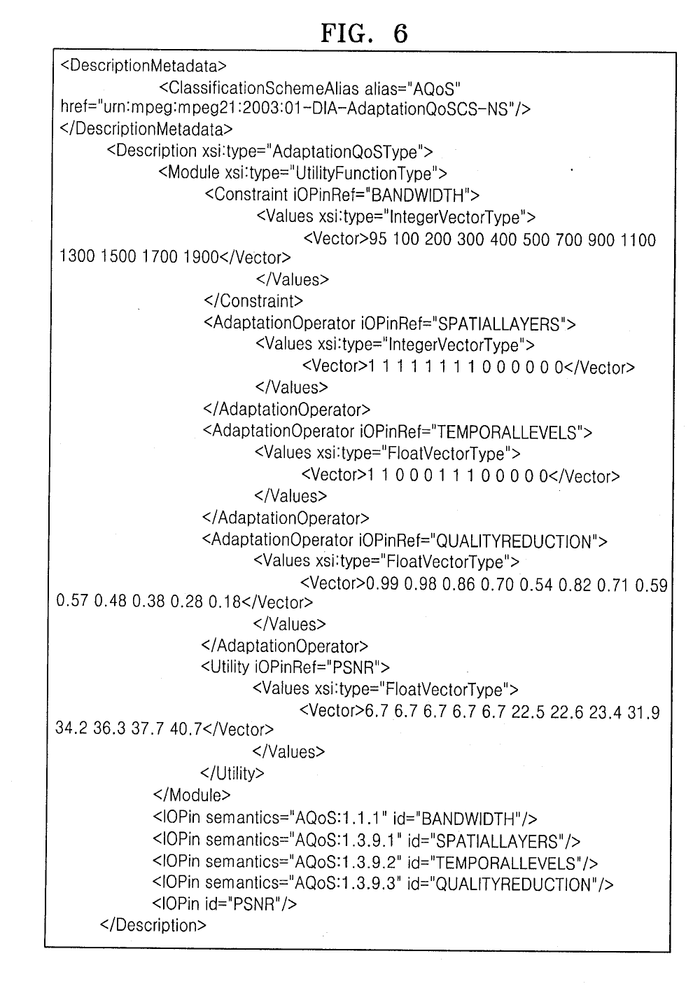

When the Adaptation QoS information of an SVC video stream is described using UtilityFunction type as illustrated in FIG. 6, it can be described by using SVC adaptation operators (Spatial Layers, Temporal Levels, Quality Reduction).

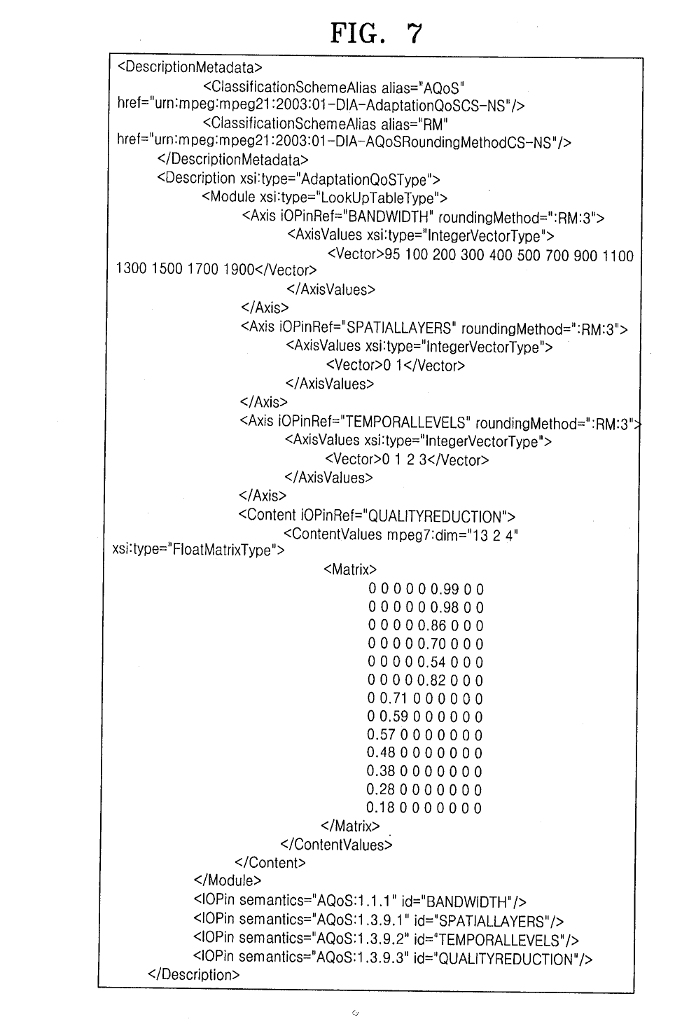

Also, when the Adaptation QoS information of an SVC video stream is described using LookupTable type as illustrated in FIG. 7, it can be described by using SVC adaptation operators (Spatial Layers, Temporal Levels, Quality Reduction).

Qfₛ ε {0, 1, . . . , n−1}, the number of spatial layers=n (1)

Spatial Layers that is an SVC adaptation operator for spatial scalability (Qfs) are expressed as equation 1 above. If the value is 0, adaptation of the spatial quality is not performed, and if the value is 1, the highest spatial enhancement layer is truncated. If the value is 2, the highest spatial enhancement layer and the second highest spatial enhancement layer are truncated.

Qf_{T} ε {0, 1, . . . , k−1}, the number of Decomposition Statges=k (2)

Temporal Levels that is an SVC adaptation operator for temporal scalability (QF_{T}) are expressed as equation 2 above. If the value is 0, adaptation of the temporal quality is not performed, and if the value is 1, the highest temporal enhancement layer is truncated. If the value is 2, the highest temporal enhancement layer and the second highest temporal quality layer are truncated.

$$\begin{matrix}{Qf}_{SNR} = \frac{{TQ}_{SNR}}{{OQ}_{SNR}} , ( 0.00 \leq {QF}_{SNR} \leq 1.00 ) \\ {TQ}_{SNR} = {\sum }_{i = 1}^{{n}^{*} - 1} {B}_{i}^{FGS} + β {n}^{*} \\ {OQ}_{SNR} = {\sum }_{i = 1}^{n} {B}_{i}^{FGS}\end{matrix} \qquad ( 3 )$$

Here, TQ_{SNR} is the SNR bitrate of the video quality to be truncated for adaptation of the SNR quality satisfying the constraints, OQ_{SNR} is the SNR bitrate of the input original video, Bᵢ^{FGS} is the bitrate of i-th highest FGS layer, n* is the number of FGS layers to be truncated, βn* is an FGS fraction to be truncated, and n is the number of FGS layers of the original video. Quality Reduction that is an SVC adaptation operator for SNR scalability (QF_{SNR}) is expressed as equation 3 above. If the value is 0.00, adaptation of the SNR quality is not performed, and if the value is 1.00, the highest SNR enhancement layer is truncated.

In the case of the FGS, if the value is 0.30, 30% of all the FGS enhancement layers is truncated, and only 70% of all the FGS enhancement layers is extracted.

$$\begin{matrix}{Qf}_{SNR} = \frac{{TQ}_{SNR}}{{OQ}_{SNR}} , ( 0.00 \leq {QF}_{SNR} \leq 1.00 ) \\ {TQ}_{SNR} = {\sum }_{i = 1}^{{m}^{*}} {B}_{k}^{CGS} \\ {OQ}_{SNR} = {\sum }_{k = 1}^{m} {B}_{k}^{CGS}\end{matrix} \qquad ( 4 )$$

Here, OQ_{SNR} is the bitrate of the SNR quality of the input original video, TQ_{SNR} is the SNR bitrate of the SNR quality to be truncated, Bₖ^{CGS} is the bitrate of a k-th highest CGS layer, and m* is the number of highest CGS layers to be truncated. In the case of the CGS, SNR quality can be provided in units suitable for the bitrate included in each CGS layer. For example, if 2 CGS layers exist, and the first CGS layer(the second highest CGS layer in this case) includes 70% of all the SNR quality layers, and the second CGS layer (the first highest CGS layer in this case) includes 30% of all the SNR quality layers, three SNR adaptation qualities, 1.00, 0.30, and 0.00, can be described in the Adaptation QoS information (AQoS). If the value is 1.00, all CGS quality layers are truncated, if the value is 0.30, the second CGS layer (the first highest CGS layer), corresponding to 30% of all the SNR quality layers, is truncated, and if the value is 0.00, all CGS layers are extracted, thereby performing adaptation of the SNR quality.

$$\begin{matrix}{Qf}_{SNR} = \frac{{TQ}_{SNR}}{{OQ}_{SNR}} , ( 0.00 \leq {QF}_{SNR} \leq 1.00 ) \\ {TQ}_{SNR} = {\sum }_{i = 1}^{{m}^{*} - 1} ( {B}_{i}^{CGS} + {\sum }_{j = 1}^{{n}_{i}} {B}_{i , j}^{FGS} ) + {β}_{{m}^{*} {n}^{*}} \\ {OQ}_{SNR} = {\sum }_{i = 1}^{m} ( {B}_{i}^{CGS} + {\sum }_{j = 1}^{{n}_{i}} {B}_{i , j}^{FGS} )\end{matrix} \qquad ( 5 )$$

Here, TQ_{SNR} is the SNR bitrate to be truncated, OQ_{SNR} is the SNR bitrate of the input original video, Bᵢ^{CGS} is the bitrate of the i-th highest CGS layer, B_{i,j}^{FGS} is the bitrate of the j-th highest FGS layer of i-th highest CGS layer, β_{m*n*} is the bitrate of an FGS fraction of the n*-th highest FGS layer of the m*-th highest CGS layer to be truncated, nᵢ is the number of FGS layers of the i-th highest CGS layer, m is the number of the CGS layers of the original video, and m* is the number of highest CGS layers to be truncated.

If the FGS and CGS are used at the same time, for example, if 2 CGS layers exist and the FGS is applied, adaptation of more precise SNR quality is enabled compared to the case when only the CGS is used. If the first CGS layer and its FGS layer respectively include 40% and 20% of all the SNR quality, and the second CGS layer and its FGS layer respectively include 30% and 10% of all the SNR quality, in order to apply a Quality Reduction of 0.45, all the second CGS layer and the FGS layer of the second CGS layer are truncated, and 5% of the FGS layer of the first CGS layer is fraction-truncated, thereby performing more precise adaptation of the SNR quality than when only the CGS is used.

Qf_{SNR}^{x}=Qf_{SNR}^{P}−(Bₓ−B_{P})/OQ_{SNR}

Qf_{S}^{x}=Qf_{S}^{P}

Qf_{T}^{x}=Qf_{T}^{P} (6)

Here, Qf_{SNR}^{x}, Qf_{S}^{x}, and Qf_{T}^{x} are values of Quality Reduction, Spatial Layers, and Temporal Levels, respectively, at an arbitrary point x existing in a quality interval {O,P}, and Qf_{SNR}^{P}, Qf_{S}^{P}, and Qf_{T}^{P} are values of Quality Reduction, Spatial Layers, and Temporal Levels, respectively, at a base quality point (P) in the quality interval {O,P}. Bₓ and B_{P} are available transmission bitrates at the arbitrary point x and the base quality point (P), respectively, and OQ_{SNR} is the SNR bitrate of the input original video.

For example, when the bitrate of the SNR quality of the original input video is 1 Mbps, a currently available transmission bitrate is 500 kbps, an transmission bitrate at the base quality point (P) is 400 kbps, and it is described that Quality Reduction is 0.7, Spatial Layers are 1, Temporal Levels are 1, Quality Reduction at the currently available transmission bitrate is determined to be 0.6 (=0.7−(500−400)/1000), Spatial Layers are determined to be 1, and Temporal Levels are determined to be 1.

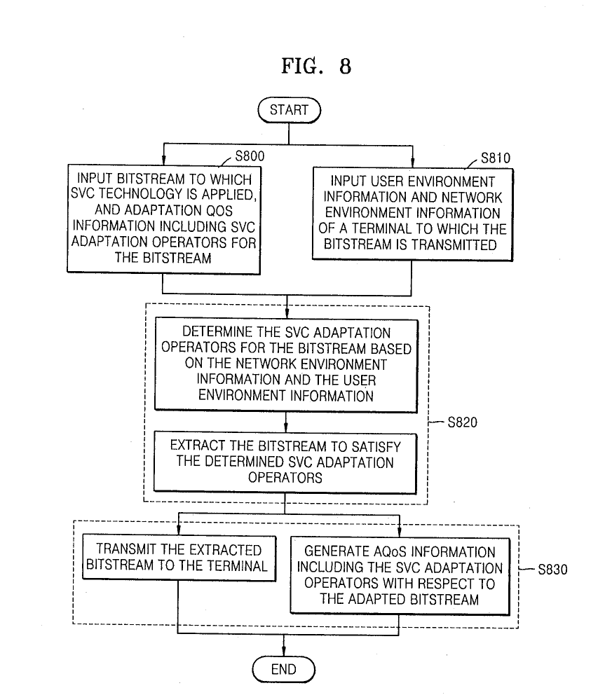

FIG. 8 is a flowchart illustrating a method of adapting a bitstream according to an embodiment of the present invention.

The method includes an operation S800 for digital item inputting in which a bitstream to which SVC technology is applied, and Adaptation QoS information including SVC adaptation operators for the bitstream are input, and an operation S810 for user environment information and network environment information of a terminal to which the bitstream is transmitted is inputted.

Then, in operation S820 for adaptation processing, the SVC adaptation operators for the bitstream based on the network environment information and the user environment information is determined, and the bitstream to satisfy the determined SVC adaptation operators is extracted. In operation S830 for digital item outputting, the extracted bitstream is transmitted to the terminal, and an Adaptation QoS information including the SVC adaptation operators with respect to the adapted bitstream is generated.

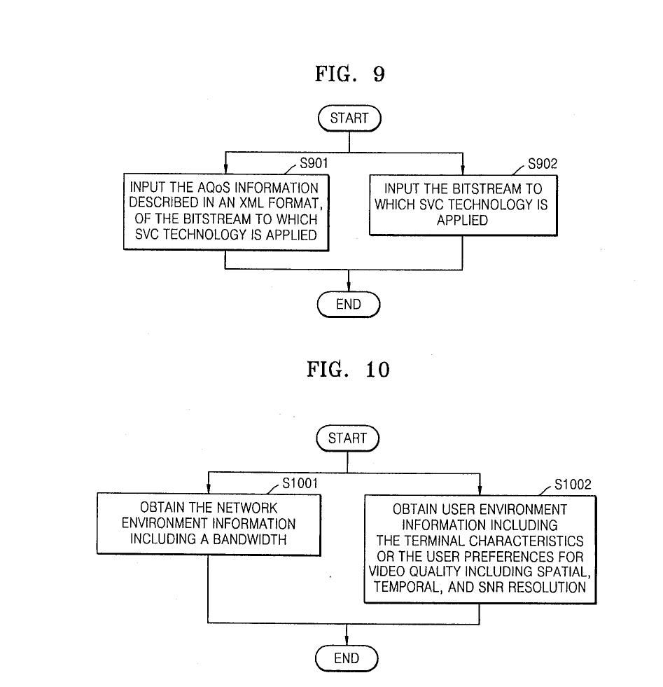

FIG. 9 is a flowchart illustrating an operation for inputting a digital item in a method of adapting a bitstream according to an embodiment of the present invention.

In the digital item inputting operation, the Adaptation QoS information described in an XML format, of the bitstream to which SVC technology is applied is input in operation S901, and the bitstream to which SVC technology is applied is input in operation S902.

In this way, the Adaptation QoS information and the digital item of the bitstream are input.

FIG. 10 is a flowchart illustrating an operation for inputting usage environment information in a method of adapting a bitstream according to an embodiment of the present invention.

The network environment information including a bandwidth is obtained in operation S1001, and the user environment information including the terminal characteristics or the user preferences for video quality including spatial, temporal, and SNR resolution is obtained in operation S1002. Then, the network and user environment information is used as basic information for determining SVC adaptation operators.

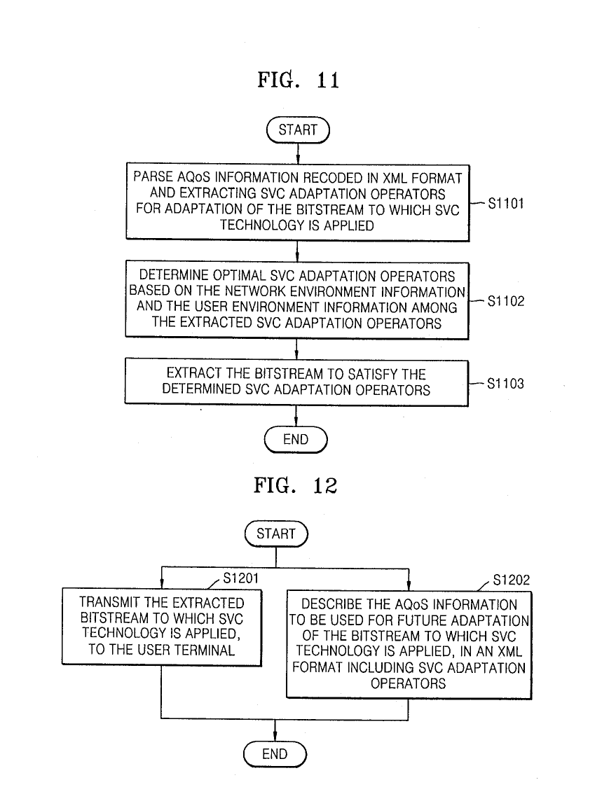

FIG. 11 is a flowchart illustrating an operation for processing adaptation in a method of adapting a bitstream according to an embodiment of the present invention.

In the adaptation processing, parsing Adaptation QoS information and extracting SVC adaptation operators for adaptation of the bitstream to which SVC technology is applied in operation S1101.

Optimal SVC adaptation operators based on the network environment information and the user environment information among the extracted SVC adaptation operators is determined in operation S1102.

The bitstream to satisfy the determined SVC adaptation operators is extracted in operation S1103.

FIG. 12 is a flowchart illustrating an operation for outputting a digital item in a method of adapting a bitstream.

The extracted bitstream to which SVC technology is applied, to the user terminal is transmitted in operation S1201.

The Adaptation QoS information to be used for future adaptation of the bitstream to which SVC technology is applied, in an XML format including SVC adaptation operators is described in operation S1202.

### INDUSTRIAL APPLICABILITY

According to the present invention as described above, the Adaptation QoS information for adapting an SVC video stream can be described generally, and by using the described Adaptation QoS information, SVC adaptation can be performed. Since SVC adaptation operators capable of supporting the SVC adaptation have not been supported so far, Adaptation QoS information (AQOS description) for adaptation of an SVC video stream can be described generally based on the present invention. Based on the description, the method and system of the present invention capable of supporting adaptation can effectively support SVC adaptation.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

1. An apparatus for adapting a bitstream to which scalable video coding (SVC) technology is applied, comprising:
an Adaptation QoS information extraction unit extracting SVC adaptation operators, and relationships between the SVC adaptation operators and the usage environment information of a terminal from the Adaptation QoS information on the bitstream to which SVC technology is applied;
an Adaptation Decision Taking Engine(ADTE) unit determining the SVC adaptation operators corresponding to the usage environment of the terminal receiving the transmitted bitstream among the SVC adaptation operators; and
a SVC bitstream extraction unit extracting the bitstream based on the determined SVC adaptation operator.

2. The apparatus of claim 1, wherein the Adaptation QoS information comprises information on SVC adaptation operators for spatial scalability, temporal scalability and SNR scalability among the standardized SVC adaptation operators.

3. The apparatus of claim 1, wherein the Adaptation QoS information describes relationships among usage environment information of terminal, SVC adaptation operators for spatial scalability, temporal scalability and SNR scalability, and measurements indicating the overall quality of the bitstream such as a peak SNR(PSNR) and utility rank.

4. The apparatus of claim 1, wherein the Adaptation QoS information includes descriptions paired with the bandwidth of the terminal, SVC adaptation operators for the spatial scalability, the temporal scalability and the SNR scalability, and the PSNR vector having identical degrees in the bandwidth of the terminal, SVC adaptation operators for the spatial scalability, the temporal scalability and the SNR scalability, and the PSNR vectors formed with an arbitrary degree.

5. The apparatus of claim 1, wherein the Adaptation QoS information includes descriptions paired with the bandwidth of the terminal, SVC adaptation operators for the spatial scalability and the temporal scalability having identical degrees in the bandwidth of the terminal, and SVC adaptation operators for the spatial scalability and the temporal scalability formed with an arbitrary degree and expressed SVC adaptation operators for the SNR scalability in the form of a matrix.

6. The apparatus of claim 1, wherein the usage environment information comprises network environment information and user environment information, the network environment information includes a bandwidth, and the user environment information includes the terminal characteristics or the user preferences for video quality including spatial, temporal, and SNR resolution.

7. The apparatus of claim 1, wherein the SVC adaptation operators determined by the ADTE unit comprises information on the SVC adaptation operators for the spatial scalability, the temporal scalability, and the SNR scalability among the standardized SVC adaptation operators.

8. The apparatus of claim 1, wherein the bitstream extracted by the SVC bitstream extraction unit satisfies the SVC adaptation operators for the spatial scalability, the temporal scalability, and the SNR scalability among the standardized SVC adaptation operators.

9. The apparatus of claim 1, wherein the Adaptation QoS information extraction unit extracts information on SVC adaptation operators for the spatial scalability, the temporal scalability, and the SNR scalability among the standardized SVC adaptation operators.

10. The apparatus of claim 1, wherein the ADTE unit determines optimal SVC adaptation operators for the spatial scalability, the temporal scalability, and the SNR scalability satisfying the usage environment, among the standardized SVC adaptation operators.

11. The apparatus of claim 1, wherein the ADTE unit determines an SVC adaptation operator for SNR scalability by finding the appropriate value of the SVC adaptation operator for SNR scalability that satisfies an available bandwidth of terminal in the range of the highest quality point and the base quality point for the specific value of the SVC adaptation operator for spatial scalability and the specific value of the SVC adaptation operator for temporal scalability.

12. The apparatus of claim 1, wherein the SVC bitstream extraction unit extracts the bitstream to satisfy the determined SVC adaptation operators for the spatial scalability, the temporal scalability, and the SNR scalability among the standardized SVC adaptation operators.

13. The apparatus of claim 1, wherein when the bitstream is adapted to satisfy the SVC adaptation operator for the spatial scalability among the standardized SVC adaptation operators, the SVC bitstream extraction unit numerically expresses an SVC adaptation operator for the spatial scalability corresponding to the number of the spatial enhancement layers to be truncated, and, according to the value of the SVC adaptation operator for spatial scalability, the SVC bitstream extraction unit does not perform adaptation for spatial scalability or truncates the same number of the highest spatial enhancement layers of the bitstream as the value of the SVC adaptation operator for the spatial scalability, thereby performing adaptation.

14. The apparatus of claim 1, wherein when the bitstream is adapted to satisfy the SVC adaptation operator for the temporal scalability among the standardized SVC adaptation operators, the SVC bitstream extraction unit numerically expresses an SVC adaptation operator for the temporal scalability corresponding to the number of the temporal enhancement layers to be truncated, and according to the value of the SVC adaptation operator for temporal scalability, the SVC bitstream extraction unit dose not perform adaptation for temporal scalability or truncates the same number of the highest temporal layers of the bitstream as the value of the SVC adaptation operator for the temporal scalability, thereby performing adaptation.

15. The apparatus of claim 1, wherein when the bitstream is adapted to satisfy the SVC adaptation operator for a fine grain scalability (FGS) of an SNR scalability among the standardized SVC adaptation operators, according to the SVC adaptation operator for the FGS of SNR scalability that is the ratio of the sum of bitrates of the FGS layers and part of an FGS layer to be truncated to the sum of bitrates of the entire FGS layers of the bitstream, the SVC bitstream extraction unit does not perform adaptation for the SNR scalability or truncates the FGS layers starting from the highest FGS layer.

16. The apparatus of claim 1, wherein when the bitstream is adapted to satisfy the SVC adaptation operator for a coarse grain scalability (CGS) of an SNR scalability among the standardized SVC adaptation operators, the SVC bitstream extraction unit truncates the CGS quality layers according the ratio of the sum of the bit rates of the highest CGS layers to be truncated to the sum of the bitrates of the entire CGS layers of the bitstream, thereby performing adaptation.

17. The apparatus of claim 1, wherein when the bitstream is adapted to satisfy the SVC adaptation operator for the FGS and CGS of an SNR scalability among the standardized SVC adaptation operators, according to the SVC adaptation operator for the FGS and CGS of an SNR scalability that is the ratio of the sum of the bit rates of the CGS layers to be truncated, the bitrates of the FGS layers associated to the CGS layers to be truncated, and the bitrates of the FGS layers and the part of FGS layers to be truncated to the sum of the bitrates of the entire CGS layers and the entire FGS layers of the bitstream, the SVC bitstream extraction unit truncates an appropriate number of the highest CGS layers or highest FGS layers to satisfy the ratio, thereby performing adaptation.

18. The apparatus of claim 1, wherein the Adaptation QoS information on the bitstream to which SVC technology is applied is recorded in XML format.

19. The apparatus of claim 1, further comprising an Adaptation QoS information description unit describing the Adaptation QoS information of the bitstream, to which SVC technology is applied and that is adapted through the SVC bitstream extraction unit, with SVC adaptation operators.

20. An apparatus for adapting a bitstream to which SVC technology is applied, comprising:
a digital item input unit inputting the bitstream to which SVC technology is applied, and Adaptation QoS information including SVC adaptation operators for the bitstream;
an usage environment information input unit in which user environment information and network environment information of a terminal to which the bitstream is transmitted is inputted;
an adaptation processing unit determining the SVC adaptation operators for the bitstream based on the network environment information and the user environment information, and extracting the bitstream to satisfy the determined SVC adaptation operators; and
a digital item output unit transmitting the bitstream extracted by the adaptation processing unit, to the terminal, and generating an Adaptation QoS information including the SVC adaptation operators with respect to the adapted bitstream extracted by the adaptation processing unit.

21. The apparatus of claim 20, wherein the digital item input unit comprises:
an Adaptation QoS information input unit in which the Adaptation QoS information described in an XML format, of the bitstream to which SVC technology is applied is inputted; and
an SVC video input unit in which the bitstream to which SVC technology is applied is inputted.

22. The apparatus of claim 20, wherein the usage environment information input unit comprises:
a network environment information input unit obtaining network environment information including a bandwidth; and
a user environment information input unit obtaining user environment information including the terminal characteristics or the user preferences for video quality including spatial, temporal, and SNR resolution.

23. The apparatus of claim 20, wherein the adaptation processing unit comprises:
an Adaptation QoS information extraction unit parsing Adaptation QoS information recorded in XML format and extracting SVC adaptation operators for adaptation of the bitstream to which SVC technology is applied;
an ADTE unit determining optimal SVC adaptation operators based on the network environment information and the user environment information among the extracted SVC adaptation operators; and
an SVC bitstream extraction unit extracting the bitstream to satisfy the determined SVC adaptation operators.

24. The apparatus of claim 20, wherein the digital item output unit comprises:
an adaptation SVC bitstream output unit transmitting the extracted bitstream to which SVC technology is applied, to the user terminal; and
an Adaptation QoS information description unit describing the Adaptation QoS information to be used for future adaptation of the bitstream to which SVC technology is applied, in an XML format including SVC adaptation operators.

25. A method of adapting a bitstream to which SVC technology is applied, the method comprising:
extracting SVC adaptation operators, and relationships between the SVC adaptation operators and the usage environment information of a terminal from the Adaptation QoS information of the bitstream to which SVC technology is applied;
determining the SVC adaptation operators corresponding to the usage environment of the terminal receiving the transmitted bitstream among the SVC adapatation operators; and
extracting the bitstream based on the determined SVC adaptation operators.

26. The method of claim 25, wherein the Adaptation QoS information comprises information on SVC adaptation operators for spatial scalability, temporal scalability and SNR scalability among the standardized SVC adaptation operators.

27. The method of claim 25, wherein the Adaptation QoS information describes relationships among usage environment information of terminal, SVC adaptation operators for spatial scalability, temporal scalability and SNR scalability, and measurements indicating the overall quality of the bitstream such as a peak SNR(PSNR) and utility rank.

28. The method of claim 25, wherein the Adaptation QoS information includes descriptions paired with the bandwidth of the terminal, SVC adaptation operators the spatial scalability, the temporal scalability and the SNR scalability, and the PSNR vector having identical degrees in the bandwidth of the terminal, SVC adaptation operators for the spatial scalability, the temporal scalability and the SNR scalability, and the PSNR vectors formed with an arbitrary degree.

29. The method of claim 25, wherein the Adaptation QoS information includes descriptions paired with the bandwidth of the terminal, SVC adaptation operators for the spatial scalability and the temporal scalability having identical degrees in the bandwidth of the terminal, and SVC adaptation operators for the spatial scalability and the temporal scalability formed with an arbitrary degree and expressed SVC adaptation operators for the SNR scalability in the form of a matrix.

30. The method of claim 25, wherein the usage environment information comprises network environment information and user environment information, the network environment information includes a bandwidth, and the user environment information includes the terminal characteristics or the user preferences for video quality including spatial, temporal, and SNR resolution.

31. The method of claim 25, wherein the determined SVC adaptation operators comprises information on the SVC adaptation operators for the spatial scalability, the temporal scalability, and the SNR scalability among the standardized SVC adaptation operators.

32. The method of claim 25, wherein in the extracting the bitstream, the extracted bitstream satisfies the SVC adaptation operators for the spatial scalability, the temporal scalability, and the SNR scalability among the standardized SVC adaptation operators.

33. The method of claim 25, wherein in the extracting the Adaptation QoS information including the SVC adaptation operators for the spatial scalability, the temporal scalability, and the SNR scalability among the standardized SVC adaptation operators.

34. The method of claim 25, wherein in the determining the Adaptation QoS, optimal SVC adaptation operators for the spatial scalability, the temporal scalability, and the SNR scalability satisfying the usage environment, among the standardized SVC adaptation operators is determined.

35. The method of claim 25, wherein in the determining the Adaptation QoS, an SVC adaptation operator for SNR scalability by finding the appropriate value of the SVC adaptation operator for SNR scalability that satisfies an available bandwidth of terminal in the range of the highest quality point and the base qulity point for the specific value of the SVC adaptation operator for spatial scalability and the specific value of the SVC adaptation operator for temporal scalability is determined.

36. The method of claim 25, wherein in the extracting the bitstream, the bitstream is extracted to satisfy the determined SVC adaptation operators for the spatial scalability, the temporal scalability, and the SNR scalability among the standardized SVC adaptation operators.

37. The method of claim 25, wherein in the extracting the bitstream, when the bitstream is adapted to satisfy the spatial scalability among the standardized SVC adaptation operators, the extracting the bitstream numerically expresses an SVC adaptation operator for the spatial scalability corresponding to the number of the spatial enhancement layers to be truncated, and, according to the value of the SVC adaptation operator for spatial scalability, the extracting the bitstream does not perform adaptation for spatial scalability or truncates the same number of the highest spatial enhancement layers of the bitstream as the value of the SVC adaptation operator for the spatial scalability, thereby performing adaptation.

38. The method of claim 25, wherein in the extracting the bitstream, when the bitstream is adapted to satisfy the temporal scalability among the standardized SVC adaptation operators, the extracting the bitstream numerically expresses an SVC adaptation operator for the temporal scalability corresponding to the number of the temporal enhancement layers to be truncated, and according to the value of the SVC adaptation operator for temporal scalability, the extracting the bitstream dose not perform adaptation for temporal scalability or truncates the same number of the highest temporal layers of the bitstream as the value of the SVC adaptation operator for the temporal scalability, thereby performing adaptation.

39. The method of claim 25, wherein in the extracting the bitstream, when the bitstream is adapted to satisfy the SVC adaptation operator for a fine grain scalability (FGS) of an SNR scalability among the standardized SVC adaptation operators, according to the SVC adaptation operator for the FGS of SNR scalability that is the ratio of the sum of bitrates of the FGS layers and part of an FGS layers to be truncated to the sum of bit rates of the entire FGS layers of the bitstream, the extracting the bitstream does not perform adaptation for the SNR scalability or truncates the the FGS layers starting from the highest FGS layer.

40. The method of claim 25, wherein in the extracting the bitstream, when the bitstream is adapted to satisfy the SVC adaptation operator for a coarse grain scalability (CGS) of an SNR scalability among the standardized SVC adaptation operators, the extracting the bitstream truncates the CGS quality layers according the ratio of the sum of the bitrates of the highest CGS layers to be truncated to the sum of the bitrates of the entire CGS layers of the bitstream, thereby performing adaptation.

41. The method of claim 25, wherein in the extracting the bitstream, when the bitstream is adapted to satisfy a SVC adaptation operator for the FGS and CGS of an SNR scalability among the standardized SVC adaptation operators, according to the SVC adaptation operator for the FGS and CGS of an SNR scalability that is the ratio of the sum of the bitrates of the CGS layers to be truncated, the bitrates of the FGS layers associated to the CGS layers to be truncated, and the bitrates of the FGS layers and the part of FGS layers to be truncated to the sum of the bitrates of the entire CGS layers and the entire FGS layers of the bitstream, the extracting the bitstream truncates an appropriate number of the highest CGS layers or highest FGS layers to satisfy the ratio, thereby performing adaptation.

42. The method of claim 25, wherein the Adaptation QoS information on the bitstream to which SVC technology is applied is recorded in XML format.

43. The method of claim 25, further comprising describing the Adaptation QoS information on the bitstream, to which SVC technology is applied and that is adapted through the extracting the bitstream, with SVC adaptation operators.

44. A method of adapting a bitstream to which SVC technology is applied, the method comprising:
receiving an input of the bitstream to which SVC technology is applied, and Adaptation QoS information including SVC adaptation operators for the bitstream;
receiving inputs of user environment information and network environment information of a terminal to which the bitstream is transmitted is inputted;
determining the SVC adaptation operators for the bitstream based on the network environment information and the user environment information, and extracting the bitstream to satisfy the determined SVC adaptation operators; and
transmitting the extracted bitstream to the terminal, and generating an Adaptation QoS information including the SVC adaptation operators with respect to the adapted bitstream.

45. The method of claim 44, wherein the receiving of the input of the bitstream comprises:
receiving an input of the Adaptation QoS information described in an XML format, of the bitstream to which SVC technology is applied; and
receiving an input of the bitstream to which SVC technology is applied.

46. The method of claim 44, wherein the receiving of the usage environment information comprises:
obtaining network environment information including a bandwidth; and
obtaining user environment information including the terminal characteristics or the user preferences for video quality including spatial, temporal, and SNR resolution.

47. The method of claim 44, wherein the determining of the SVC adaptation operator, and the extracting and adapting of the bitstream comprises:
parsing Adaptation QoS information recoded in XML format and extracting SVC adaptation operators for adaptation of the bitstream to which SVC technology is applied;
determining optimal SVC adaptation operators based on the network environment information and the user environment information among the extracted SVC adaptation operators; and
extracting the bitstream to satisfy the determined SVC adaptation operators.

48. The method of claim 44, wherein the transmitting of the bitstream and the generating of Adaptation QoS information comprises:
transmitting the extracted bitstream to which SVC technology is applied, to the user terminal; and
describing the Adaptation QoS information to be used for future adaptation of the bitstream to which SVC technology is applied, in an XML format including SVC adaptation operators.

49. A computer readable recording medium having embodied thereon a computer program for executing the method of any one of claim 25.
